(19) United States
(12) Patent Application Publication
(10) Pub. No.: US 2021/0110204 A1
(43) Pub. Date: Apr. 15, 2021

(54) IMAGE RECOGNITION METHOD, COMPUTER READABLE MEDIUM AND SYSTEM

(71) Applicant: The University of Manchester, Manchester (GB)

(72) Inventors: Hujun Yin, Manchester (GB); James Burnstone, Manchester (GB); Shireen Zaki, Manchester (GB)

(73) Assignee: The University of Manchester, Manchester (GB)

(21) Appl. No.: 16/500,727

(22) PCT Filed: Mar. 26, 2018
(86) PCT No.: PCT/GB2018/050783

§ 371 Date: Oct. 3, 2019

(30) Foreign Application Priority Data
Apr. 4, 2017 (GB) 1705394.3

(51) Int. Cl. G06K 9/62; G06K 9/00

(52) U.S. Cl. CPC G06K 9/6255; G06K 9/6276; G06K 9/00288; G06K 9/6215

(57) ABSTRACT

The image recognition method comprises receiving a challenge image (100); and comparing the challenge image (100) to a reference image set (400) generated from a reference image (200). The reference image set (400) comprising at least one modified reference image (401-406) having a different lighting condition to the reference image (200). The at least one modified reference image (401-406) being generated based on the reference image (200) and at least one generic image (500) generated from at least one generic 3D model (700) under the different lighting condition

The present invention is directed towards an image recognition method, computer-readable medium, and system.

One existing application of image recognition is in facial recognition. Facial recognition is the process of identifying an individual based on their facial characteristics. Although facial recognition may be performed manually, the present invention is focused on automatic facial recognition with minimal user intervention in the recognition process.

Facial recognition may be performed by comparing a challenge image of a subject person to a reference image of the same subject person. The reference image is obtained in advance and typically stored in a database. The challenge image may be extracted from a digital image or a video frame from a video source.

Existing algorithms used in facial recognition include Principal Component Analysis (PCA) and Linear Discriminant Analysis (LDA).

Principal component analysis (PCA) is used to reduce the dimensions of the image data to reveal the most effective low dimensional structure of facial patterns. This reduction in dimensions removes information that is not highly useful and decomposes the face structure of the images into orthogonal components known as eigenfaces. Using PCA, each face image may be represented as a weighted sum of the eigenfaces. A challenge image may be compared against a reference image by measuring the distance between their respective feature vectors. A primary advantage of the PCA approach is that it may reduce the data needed to identify the individual.

Linear Discriminant Analysis (LDA) is a statistical approach for classifying samples of unknown classes based on training samples with known classes. This technique aims to maximise between-class (i.e., across users) variance and minimise within-class (i.e., within user) variance.

Facial recognition has applications in security systems such as mobile payment systems, ATM security systems, and desktop/laptop and mobile applications. Facial recognition can be used as an alternative form of user login to the traditional form of manually entering passwords. In addition, and unlike other forms of biometric identification, such as fingerprints and iris recognition, facial recognition avoids the need for the subject to physically contact or interact with the recognition system. Willing user participation is not required, and covert surveillance can be performed. In addition, facial recognition can be incorporated easily into existing surveillance systems such as closed circuit television (CCTV).

Existing facial recognition systems may perform satisfactory image recognition when operating under controlled conditions such as frontal lighting and pose. That is, when both the reference image and the challenge image are obtained under the same uniform lighting.

However, the provision of challenge images under uncontrolled conditions including uncontrolled illumination (e.g. challenge images acquired by surveillance and security systems cameras—CCTV, and challenge images obtained using mobile phones with cameras) can challenge these existing systems. Many existing facial recognition systems significantly drop in accuracy when the lighting conditions of the challenge image and reference image are different.

There are existing systems that attempt to cope with uncontrolled illumination.

One such existing system generates harmonic images of illuminations. However, this existing system requires many reference images of each subject person. In particular, multiple reference images of each subject person are required under varied lighting conditions to cope with the potential variations in lighting of a future challenge image. In this existing system, the more reference images taken under the different lighting conditions, the better the modelling of the illumination. Obtaining these multiple reference images of a single subject person under different lighting conditions is time consuming and impractical. In most image recognition applications only a single reference image for each subject person to be recognised will be available.

In another existing system, a 3D scan of the subject person is obtained to artificially generate images of the subject person with varied lighting conditions. In this existing system, a 3D scanner needs to be deployed at least when obtaining the reference image, and may also be required during the actual image recognition stage. This is again impractical, expensive and not suitable for use with existing image recognition applications which often only have a single reference image available for each subject person to be recognised.

It is an objective of the present invention to solve at least some of the problems outlined above, or at least provide an alternative image recognition method, computer-readable medium, and system.

Accordingly, the present invention provides an image recognition method comprising: receiving a challenge image; and comparing the challenge image to a reference image set generated from a reference image, the reference image set comprising at least one modified reference image having a different lighting condition to the reference image, the at least one modified reference image being generated based on the reference image and at least one generic image generated from at least one generic 3D model under the different lighting condition.

Here, “challenge image” refers to an image to be recognised by the image recognition method. The challenge image may be an image of unknown or unidentified subject matter. For example, if the image recognition method is for facial recognition, then the challenge image may be an image of an unidentified person.

Here, “reference image” may refer to a pre-obtained image. The reference image may be of already known or identified subject matter. For example, if the image recognition method is for facial recognition, then the reference image may be an image of an identified person. The reference image may be obtained during a registration stage.

Here, “at least one generic image” refers to an image of a generic object rather than a specific object. For example, if the image recognition method is for facial recognition, then the generic image is a non-person-specific image of a face. In other words, it is an image which has general facial characteristics, but does not resemble or is not generated from a specific person.

Here, “at least one generic 3D model” refers to a 3D model of a generic object rather than a specific object. For example, if the image recognition method is for facial recognition, then the generic 3D model is a non-person-specific 3D model of a face. In other words, the generic 3D model has general facial characteristics, but does not resemble or is not generated from a specific person. The generic 3D model may be a computer generated 3D model.

Advantageously, the present invention compares the challenge image to the reference image set comprising at least one modified reference image having a different lighting condition to the reference image. In this way, the present invention is able to account for variations in lighting conditions between the challenge image and the reference image. The present invention does not require using a 3D camera to obtain 3D reference images and challenge images. In addition, the present invention does not require obtaining multiple reference images under different lighting conditions for each subject to be recognised. Instead, the present invention is able to use a single reference image of each subject to be recognised, and then use this single reference image with at least one generic image generated from at least one generic 3D model to generate at least one modified reference image having a different lighting condition to the reference image. In other words, the present invention is advantageously artificially generating different lighting conditions for the reference image. The different lighting conditions for the reference image are created computationally.

Advantageously still, the present invention provides a more practical and economical way for generating the reference image set for use in image recognition where the challenge image may have a different lighting condition to the originally obtained reference image. The use of at least one generic 3D model means that the image recognition method has the potential to access a practically unlimited number of different generic 3D models which can be arranged in different positions and orientations. In facial recognition, the at least one generic 3D model can be used to account for changes in subjects' age, weight and skin tone. This is more efficient than taking additional reference images of the subject to be recognised under varying lighting conditions. The at least one generic 3D models enables the simulation of a large number of lighting conditions.

The at least one modified reference image may be generated based on the reference image and a plurality of generic images. The plurality of generic images may be generated from a plurality of generic 3D models under the different lighting condition.

Advantageously, the present invention can use a plurality of generic 3D models to generate the generic images. The generic 3D models may each have a different appearance. For example, if the image recognition method is for facial recognition, then each generic 3D model may have a different facial appearance. The plurality of generic 3D models may represent different ethnicities, different genders, and/or different ages. The use of the plurality of generic 3D models may improve the image recognition accuracy. Creating a wide variety of specific 3D images based on real subjects would be impractical and time consuming. The use of generic 3D models according to the present invention advantageously enables the building of a diverse training set for image recognition much more efficiently. The customisable quality of the models means that this training set can easily respond to a specific need, such as images under a certain illumination or with the addition of a particular feature. The generic 3D models may differ from one another in ways which include face shape, nose length, angles of the ears and positioning of the lips. This allows for the possibility of numerous different faces. The generic 3D models may provide a large, diverse image set for changing illumination conditions.

The reference image set may comprise a plurality of modified reference images having a plurality of different lighting conditions. In this way, the image recognition method may provide an illumination invariant image recognition method in which modified reference images with different lighting conditions may be generated from a single reference image. This improves the image recognition accuracy when the challenge image may be captured under any unknown lighting condition. The use of generic 3D models rather than person specific or manually captured 3D images means that the image recognition method of the present invention is computationally efficient and more practical. Using generic 3D models to generate generic images having different lighting conditions is a surprisingly efficient way to account for lighting variations between the challenge image and the reference image.

Comparing the challenge image to the reference image set may comprise determining whether the challenge image matches an image of the reference image set so as to determine whether the challenge image matches the reference image. The image recognition method may comprise comparing the challenge image to each image of the reference image set to determine the similarity of the challenge image to each image. If the similarity is above a predetermined threshold, then the image recognition method may determine that the challenge image matches the reference image used to generate the reference image set.

The at least one modified reference image may be generated using the reference image and a mathematical expression derived from the at least one generic image. The mathematical expression may describe or represent the lighting condition of the at least one generic image such that when the mathematical expression is applied to the reference image, the modified reference image generated as a result has a lighting condition derived from the at least one generic image. The at least one modified reference image may be generated by applying one or more principal components of the at least one generic image to the reference image. Applying one or more principal components of the at least one generic image to the reference image may comprise applying an eigenvector set generated from the at least one generic image to the reference image. Generating an eigenvector set may comprise generating eigenimages from the at least one generic image. Advantageously, using a mathematical expression derived from the at least one generic image, or using one or more principal components of the at least one generic image may reduce the computational requirements of the image recognition method.

The reference image set may comprise one or more modified reference images having different poses to the reference image.

Here, “pose” means that at least some of the subject matter of the one or modified reference images has a different orientation to the reference image. For example, in facial image recognition, pose may refer to a different orientation of the face. The reference image may be obtained in controlled conditions such that the face is directly facing the camera. The challenge image may be captured in a live setting and have a different pose to the reference image. This may reduce the image recognition accuracy. Advantageously, however, by generating one or more modified reference images having different poses to the reference image, the image recognition method is able to account for the pose variations between the challenge and the reference image to improve the recognition accuracy.

The one or more modified reference images having different poses to the reference image may be generated using one or more pose components. The one or more pose components may be extracted from a plurality of library images, the plurality of library images having subject matter arranged in different poses. The one or more pose components may be mathematical expressions extracted from landmark features of the plurality of library images. The mathematical expressions may describe or represent the poses of the plurality of library images such that when the mathematical expressions are applied to the reference image, the modified reference image generated as a result has a pose derived from the plurality of library images.

Comparing the challenge image to the reference image set may comprise comparing the challenge image to a plurality of reference image sets, each reference image set being generated from a different reference image. Advantageously, the image recognition method is able to compare the challenge image to a plurality of reference image sets generated from different reference images. In facial recognition applications, each reference image may be a different person.

Each reference image set may comprise a plurality of modified reference images. The plurality of modified reference images may have different poses and lighting conditions to the reference image. Comparing the challenge image to the reference image set may comprise comparing the challenge image to each of the reference image sets to determine the image which is the closest match to the challenge image so as to determine which of the reference images is the closest match to the challenge image.

The image recognition method may be for use in facial recognition. The generic 3D model may be a generic 3D model of a face. The reference image may be a reference face image. The challenge image may be a challenge face image.

Accordingly, the present invention further provides an image recognition method comprising: providing a reference image; and generating a reference image set from the reference image, wherein generating the reference image set comprises generating at least one modified reference image having a different lighting condition to the reference image, and wherein the at least one modified reference image is generated based on the reference image and at least one generic image generated from at least one generic 3D model under the different lighting condition.

The method may further comprise generating the at least one generic 3D model.

The method may further comprise applying the different lighting condition to the at least one generic 3D model.

The method may further comprise generating the at least one generic image from the at least one generic 3D model under the different lighting condition.

Applying the different lighting condition to the at least one generic 3D model may comprise applying a plurality of different lighting conditions to the at least one generic 3D model. The plurality of different lighting conditions may be of a sufficient number for a wide number of lighting conditions to be represented in the generic images.

Generating the at least one generic image may comprise generating a plurality of generic images from the at least one generic 3D model under the plurality of different lighting conditions.

The method may further comprise generating one or more principal components of the at least one generic image. Generating one or more principal components of the at least one generic image may comprise generating an eigenvector set from the at least one generic image. The at least one generic image therefore acts as a training set. Generating an eigenvector set may comprise generating eigenimages from the at least one generic image.

The at least one modified reference image may be generated based on the reference image and a plurality of generic images generated from a plurality of generic 3D models.

The method may further comprise applying a plurality of different lighting conditions to the plurality of generic 3D models to generate a plurality of generic images having a plurality of different lighting conditions.

Generating the reference image set may further comprise generating one or more modified reference images having different poses to the reference image.

The one or more modified reference images having different poses to the reference image may be generated using one or more pose components.

The method may further comprise extracting the one or more pose components from a plurality of library images. The plurality of library images may have subject matter arranged in different poses.

Providing the reference image may comprise providing a plurality of reference images. Generating the reference image set may comprise generating a plurality of reference image sets. Each reference image set may be generated from one of the plurality of reference images.

Accordingly, the present invention further provides a computer readable medium having computer executable code for carrying out one or more of the methods described above.

The present invention further provides an image recognition system for carrying out one or more of the methods described above.

According to the present invention there is provided a method, computer readable medium, and system as set forth in the appended claims. Other features of the invention will be apparent from the dependent claims, and the description which follows.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIG. 1 is a challenge image for a subject person according to an example embodiment;

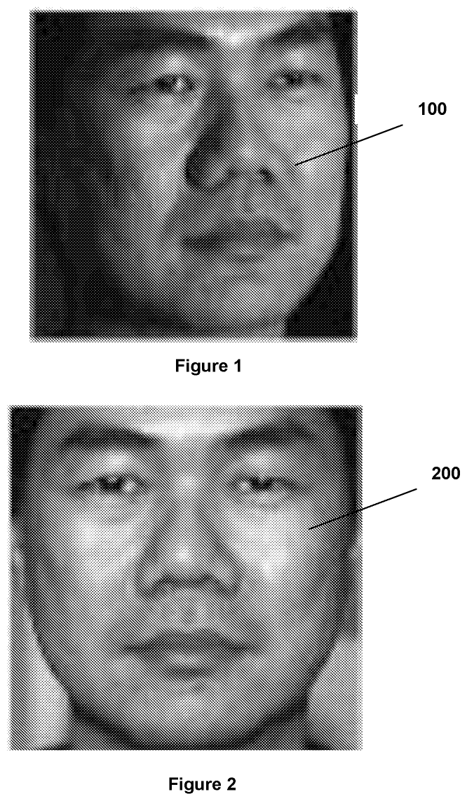

FIG. 2 is a reference image for the subject person shown in FIG. 1;

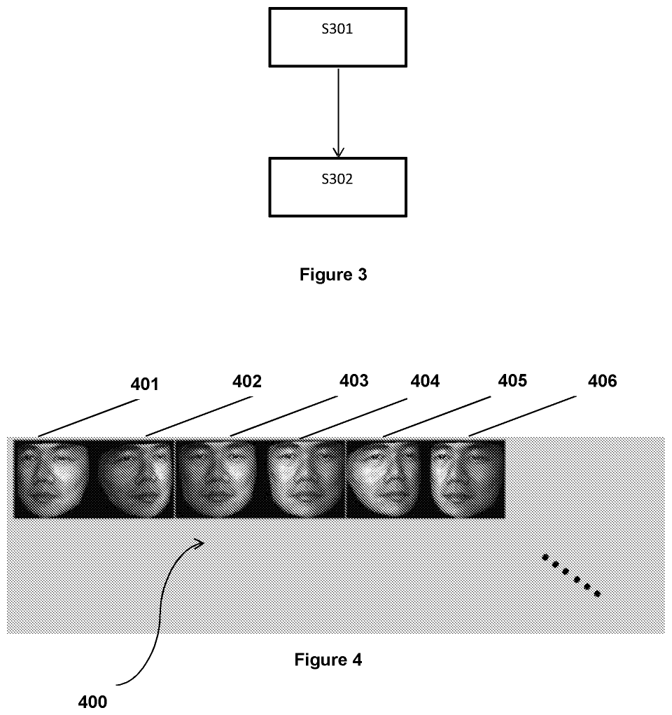

FIG. 3 is a simplified schematic diagram of a method according to an example embodiment;

FIG. 4 is a reference image set comprising a plurality of modified reference images according to an example embodiment;

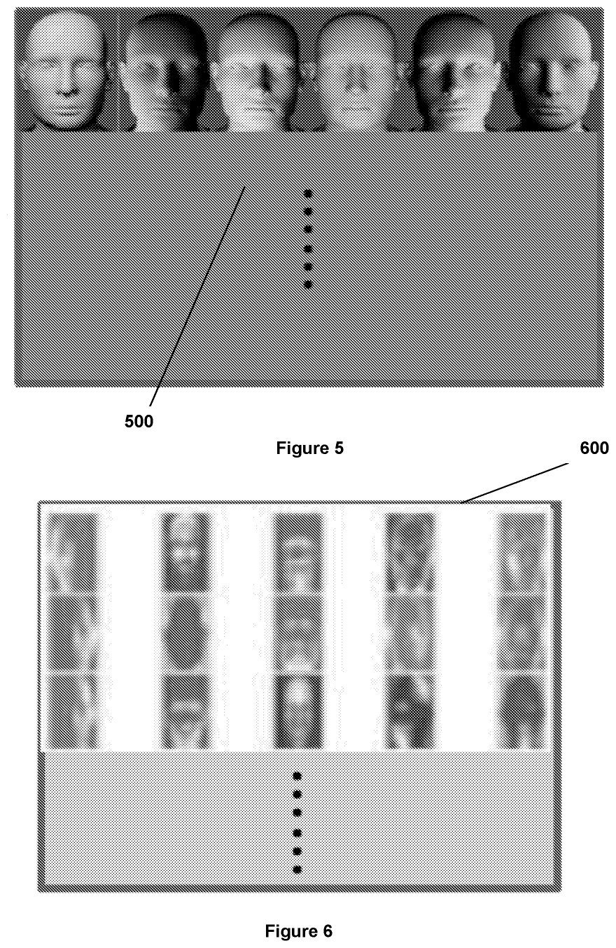

FIG. 5 shows a plurality of generic images generated from a generic 3D model under different lighting conditions according to an example embodiment;

FIG. 6 shows generated eigenimages generated from a plurality of generic images according to an example embodiment;

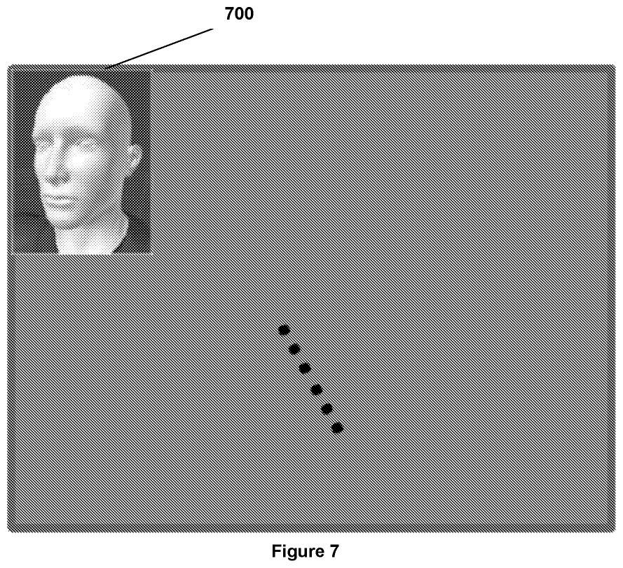

FIG. 7 shows a generic 3D model according to an example embodiment;

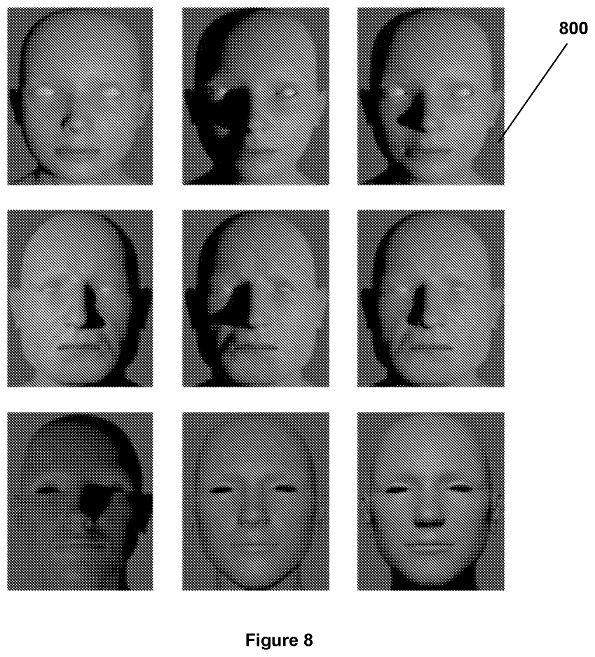

FIG. 8 shows a plurality of generic images generated from different generic 3D models under different lighting conditions according to an example embodiment;

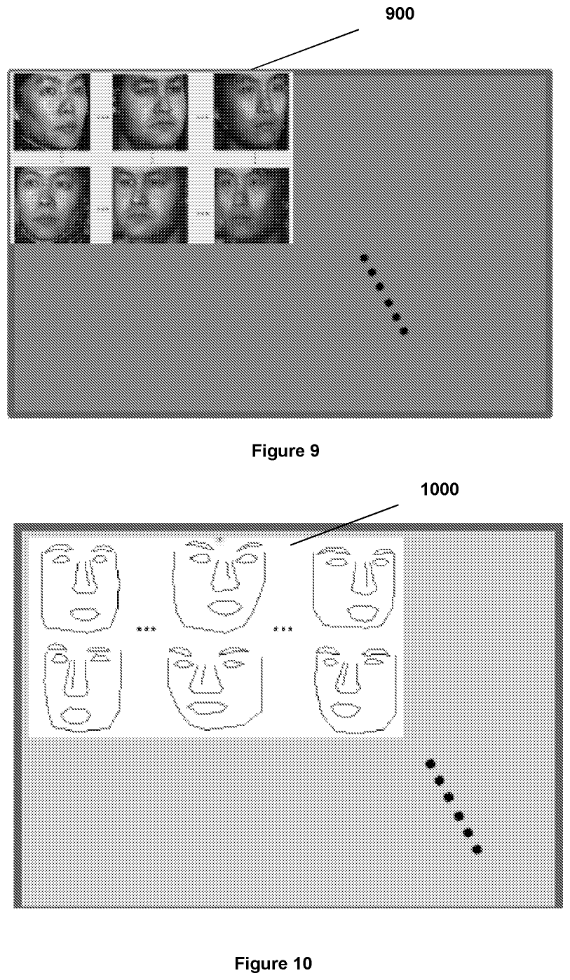

FIG. 9 is a series of library images having different poses and landmarks according to an example embodiment;

FIG. 10 is a series of principal component poses or shapes extracted from a series of library images according to an example embodiment;

FIG. 11 is a simplified schematic diagram of another method according to an example embodiment; and

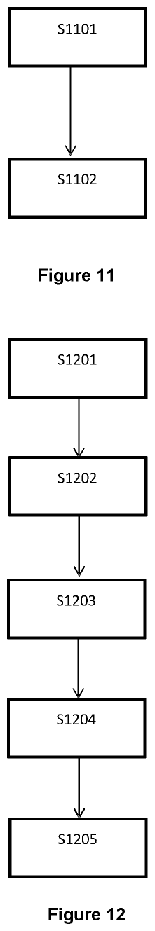

FIG. 12 is a simplified schematic diagram of yet another method according to an example embodiment.

The following discussion will focus on use of the image recognition method, computer readable medium, and system in facial recognition. It will be appreciated that the present invention is not limited to facial recognition. The image recognition method, computer readable medium, and system may be used in a variety of other applications where it is desired to determine whether a challenge image matches a reference image. These may include applications which involve recognising packaging such as bottles, products such as cars, and animals. Other applications will be appreciated by those skilled in the art.

In facial recognition, a challenge image is compared to a reference image to determine whether the challenge image matches the reference image.

Referring to FIG. 1, there is shown an example challenge image 100. The challenge image 100 is a facial image of an unidentified subject. The challenge image 100 is a 2D image.

Referring to FIG. 2, there is shown an example reference image 200 of the same subject as the challenge image 100 of FIG. 1. The reference image 200 is obtained during a registration stage and is stored in a database for subsequent use in image recognition. The reference image 200 is a 2D image.

The challenge image 100 may be obtained from a camera such as a mobile phone camera or may be extracted from a video feed such as from CCTV. The challenge image 100 is therefore obtained in an uncontrolled setting, and as a result was captured under unknown or variable lighting conditions different to the reference image 200. Some parts of the challenge image 100 have different shading to corresponding parts of the reference image 200. This difference in image shading reduces the recognition accuracy of an image recognition method which directly compares the challenge image 100 to the reference image 200. In other words, it is harder for a computer running image recognition software to determine that the challenge image 100 and the reference image 200 are of the same person due to the difference in lighting conditions.

The reference image 200 of FIG. 2 also has a different pose to the challenge image 100. The reference image 200 shows the person facing directly towards the camera, while the challenge image 100 shows the person at an angle. This difference in pose can also reduce the recognition accuracy of an image recognition method which directly compares the challenge image 100 to the reference image 200. In other words, it is harder for a computer running image recognition software to determine that the challenge image 100 and the reference image 200 are of the same person due to the difference in pose between the challenge image 100 and the reference image 200.

Therefore, directly comparing the challenge image 100 to reference image 200 is unlikely to lead to an accurate recognition result when the challenge image 100 has a different lighting condition to the reference image 200. Additionally, a difference in pose between the challenge image 100 and the reference image 200 is less likely to produce an accurate recognition result.

Referring to FIG. 3, there is shown an example image recognition method in accordance with the present invention which may be used to at least partially account for at least the difference in lighting condition between the challenge image 100 and the reference image 200.

In accordance with this method, the challenge image 100 (FIG. 1) is received at step 301. Receiving the challenge image 100 can comprise capturing the challenge image 100 using a camera or video camera of a mobile phone or other electronic device. In addition, capturing the challenge image 100 can comprise extracting the challenge image 100 from video data such as video data obtained from CCTV. Receiving the challenge image 100 can also comprise loading a previously obtained challenge image 100 from memory.

At step 302, the challenge image 100 is compared to a reference image set generated from a reference image 200 (FIG. 2). The reference image set is generated by generating at least one modified reference image having a different lighting condition to the reference image 200. The at least one modified reference image is generated based on the reference image 200 and at least one generic image generated from at least one generic 3D model under the different lighting condition. The reference image set may be generated dynamically during the image recognition method or archived for subsequent matching.

Surprisingly and advantageously, the present invention compares the challenge image 100 to a reference image set which is computationally generated based on the originally obtained reference image 200 and at least one generic image generated from at least one generic 3D model. This computationally generated reference image set enables artificial lighting conditions for the reference image 200 to be generated. In this way, differences in lighting conditions between the challenge image 100 and the reference image 200 can be mitigated. In other words, differences in lighting condition between the challenge image 100 and the reference image 200 can be mitigated using a single reference image 200.

In one example, comparing the challenge image 100 to the reference image set at step 302 comprises determining whether the challenge image 100 matches an image of the reference image set. If it is determined that the challenge image 100 does match an image of the reference image set, then it is determined that the challenge image 100 matches the reference image 200.

The present invention is not limited to any particular technique of comparing the challenge image 100 to the reference image set. The step of comparing may be performed using any known method of determining the similarity between images. The particular comparison method may be selected as appropriate by those skilled in the art. In one example, a distance measure between the challenge image 100 and each image of the reference image set will be obtained. If the distance measure indicates that the similarity between the challenge image 100 and at least one of the images of the reference image set is above a predetermined threshold, then it will be determined that the challenge image 100 matches the reference image 200. In another example, the comparison method uses a nearest neighbour algorithm to determine the similarity between the challenge image 100 and the at least one image of the reference image set. In another example, the correlation coefficient can be used to measure the similarity between the challenge image 100 and the at least one image of the reference image set.

Referring to FIG. 4, there is shown an example reference image set 400 which may be used in the image recognition method at step 302. The reference image set 400 comprises a plurality of modified reference images which in FIG. 4 are shown as the example modified reference images 401-406. The plurality of modified reference images 401-406 are generated from the reference image 200 of FIG. 2 and the at least one generic image. The plurality of modified reference images 401-406 are 2D images. The plurality of modified reference images 401-406 have different lighting conditions to the reference image 200. It will be appreciated that a plurality of modified reference images 401-406 is not required, and just one modified reference image having a different lighting condition to the reference image 200 is within the scope of the present invention. Generally, having more modified reference images 401-406 will be beneficial in terms of image recognition accuracy as a greater number of different lighting conditions will be represented. Significantly and advantageously, the present invention enables the modified reference images 401-406 having different lighting conditions to be artificially generated from the single reference image 200.

The plurality of modified reference images 401-406 are shown in FIG. 4 as having different poses to the reference image 200. It will be appreciated that it is not required that the modified reference images 401-406 have different poses to the reference image 200. Generally, having modified reference images 401-406 with different poses will be beneficial in terms of image recognition accuracy especially if the challenge image 100 is received with an unknown pose. It will be appreciated that in environments where the pose of the challenge image 100 is restricted or controlled, such pose variation in the modified reference images 401-406 is not required.

In one example, the image recognition method at step 302 comprises comparing the challenge image 100 (FIG. 1) to each image of the reference image set 400 to determine the similarity of the challenge image 100 to each image. If the similarity is above a predetermined threshold, then the image recognition method at step 302 determines that the challenge image 100 matches the reference image 200 used to generate the reference image set 400.

Referring to FIG. 5, there is shown an example of a plurality of generic images 500. The plurality of generic images 500 have different lighting conditions and are generated from generic 3D models under the different lighting conditions. It will be appreciated that a single generic image 500 generated from a single generic 3D model may be used for performing image recognition in accordance with the present invention. Generally, using a plurality of generic images 500 generated from a plurality of generic 3D models will be beneficial in terms of image recognition accuracy. The plurality of generic images 500 are 2D images.

The generic images 500 of FIG. 5 are used with the reference image 200 (FIG. 2) to generate the at least one modified reference image 401-406 (FIG. 4). This involves applying characteristics of the generic images 500 to the reference image 200. In one example, this involves determining a mathematical expression from the generic images 500, which defines or represents the lighting conditions of the generic images 500. This mathematical expression may be applied to the reference image 200 so as to generate the modified reference images 401-406 having the lighting conditions derived from the generic images 500. In one example, the characteristics may be a set of principal eigenvectors of the generic images 500. Using a set of principal eigenvectors of the generic images 500 decreases the computational complexity of generating the at least one modified reference image 401-406.

In one example, the at least one modified reference image 401-406 is generated by applying one or more principal components of the at least one generic image 500 to the reference image 200.

Referring to FIG. 6, there is shown an example of one or more principle components generated from the generic images 500. In particular, FIG. 6 shows a series of eigenimages 600 generated from the generic images 500 of FIG. 5. The eigenimages 600 are a set of principal eigenvectors of the generic images 500.

Referring to FIG. 7, there is shown an example generic 3D model 700 used to generate the generic images 500. The generic 3D model 700 is a computer generated model, and is not generated from or to represent a specific human face. An advantage of the use of the generic 3D model 700 is that it is more computationally efficient to generate a generic 3D model 700 than manually create a person-specific 3D model such as by obtaining 3D images of a person's head. It is also more practical for real image recognition applications where it would not be practical to 3D scan each subject person. The use of the generic 3D model 700 avoids the need to create specific 3D models of real subjects, which is impractical and time consuming.

In addition, the generic 3D model 700 is customisable so that it can be used to generate approximation to reference image sets 400 (FIG. 4) that respond to a specific need, such as the need of generic images 500 (FIG. 5) under a specific illumination. While only one generic 3D model 700 is specifically shown in FIG. 7, it will be appreciated that a plurality of generic 3D models 700 may be used to generate the generic images 500. The generic 3D models 700 may have different appearances such that a variety of generic images 500 are generated. For example, each generic 3D model 700 may have a different facial size or shape or weight, and may be generated such that different ethnicities, genders, and/or ages are represented in the generic images 500. Generating the generic images 500 from the generic 3D models 700 involves changing the lighting conditions applied to the generic 3D models 700 computationally. 2D projections of the generic 3D models 700 under the different lighting conditions are generated computationally to generate the generic images 500.

Advantageously, the use of the plurality of generic 3D models 700 which are generated artificially/computationally improves the image recognition accuracy. Creating a wide variety of 3D images based on real subjects would be impractical and time consuming. The use of generic 3D models 700 according to the present invention advantageously enables the building of a diverse training set for an image recognition method much more efficiently. The customisable quality of the models means that this training set can easily respond to a specific need, such as images under a certain illumination or with the addition of a particular feature. The generic 3D models 700 may differ from one another in ways which include face shape, nose length, angles of the ears and positioning of the lips. This allows for the possibility of numerous different faces. The generic 3D models 700 may provide a large, diverse image set for changing illumination conditions. The generic 3D models 700 may be split into different groups (rather than a single set). This enables better fitting to customised cases such as one fora particular ethnic group.

Referring to FIG. 8, there is shown one example where nine generic images represented generally by the reference numeral 800 have been generated from three different generic 3D models (not shown). Three generic images are generated from each of the generic 3D models, and each of the three generic images have a different lighting condition. The three different generic 3D models have different appearances, and as such the generic images 800 differ in terms of characteristics such as facial size, gender and age.

Referring again to FIG. 4, the reference image set 400 in one example comprises one or more modified reference images 401-406 having different poses to the reference image 200 (FIG. 2). The one or more modified reference images 401-406 have different poses to the reference image 200 (FIG. 2) are generated using one or more pose components. The one or more pose components are extracted from a plurality of library images having subject matter arranged in different poses. The one or more pose components are mathematical expressions extracted from landmark features of the plurality of library images. The mathematical expressions describe or represent the poses of the plurality of library images such that when the mathematical expressions are applied to the reference image 200, the modified reference images 401-406 generated as a result have poses derived from the plurality of library images. In on example, landmarks of the library images are identified. The library images with landmarks are used to extract pose components. The pose components are used to rotate the reference image 200 such that the reference image set 400 comprises a plurality of modified reference images 401-406 having a variety of poses present in the library images. It is also possible to extrapolate beyond the range of orientations present in the library images. For example, if the library images cover face poses between −30 to 30 degrees of yaw, it may be possible to generate modified face poses between −35/−40 to 35/40 degrees of yaw.

Referring to FIG. 9, there are shown examples of a set of library images indicated generally by the reference numeral 900. The library images 900 have different poses. Feature landmarks of the library images 900 are extracted and used to generate the one or more pose components. The library images 900 of FIG. 9 are real images of human faces. The library images 900 do not need to be of the same subjects as the subjects forming the reference image(s) 200. For example, in facial recognition applications the library images 900 and the reference image(s) 200 can be of different people. In some examples, the library images 900 may be generated from the generic 3D models 700.

Referring to FIG. 10, there is shown a simplified diagrammatic representation of the one or more pose components 1000. In particular, FIG. 10 shows a series of principal component poses or shapes extracted from a series of library images. The pose components 1000 are applied to the reference image 200 to generate the modified reference images 401-406 having the different poses. The pose components 1000 may be applied alongside the eigenimages 600 generated from the generic images 500 to generate the reference image set 400 having different lighting conditions and poses. The library images 900 are 2D images.

In one example, comparing the challenge image 100 (FIG. 1) to the reference image set 400 (FIG. 4) comprises comparing the challenge image 100 to a plurality of reference image sets. Each reference image set is generated from a different reference image. Each different reference image is of a different subject person to be recognised. Advantageously, the image recognition method is able to compare the challenge image 100 to a plurality of reference image sets generated from different reference images.

In one example, each reference image set comprises a plurality of modified reference images. The plurality of modified reference images may have different poses and lighting conditions to the reference image. In this example, comparing the challenge image 100 (FIG. 1) to the reference image set comprises comparing the challenge image 100 to each of the reference image sets to determine the image which is the closest match to the challenge image 100 so as to determine which of the reference images is the closest match to the challenge image 100. In this way, a challenge image 100 can be compared to reference images of multiple subject persons to determine which subject person is the closest match to the person in the challenge image 100.

Referring to FIG. 11, there is shown another example image recognition method according to the present invention. At step 1101 a reference image 200 (FIG. 2) is provided. At step 1102 a reference image set 400 (FIG. 4) is generated from the reference image 200. Generating the reference image set 400 at step 1102 comprises generating at least one modified reference image 401-406 having a different lighting condition to the reference image 200. The at least one modified reference image 401-406 is generated based on at least one eigenimage 600 (FIG. 6) which is generated from the at least one generic image 500 (FIG. 5) which is in turn generated from at least one generic 3D model 700 (FIG. 7) under the different lighting condition.

Referring to FIG. 12, there is shown another example image recognition method according to the present invention. At step 1201 at least one generic 3D model 700 (FIG. 7) is generated. At step 1202, a different lighting condition is applied to the at least one generic 3D model 700. At step 1203, at least one generic image 500 (FIG. 5) is generated from the at least one generic 3D model 700 under the different lighting condition. At step 1204 a reference image 200 (FIG. 2) is provided. At step 1205, a reference image set 400 (FIG. 4) is generated from the reference image 200. Generating the reference image set 400 at step 1205 comprises generating at least one modified reference image 401-406 having the different lighting condition to the reference image 200. The at least one modified reference image 401-406 is generated based on the reference image 200 and the at least one generic image 500.

In one example, applying the different lighting condition to the at least one generic 3D model 700 at step 1202 comprises applying a plurality of different lighting conditions to the at least one generic 3D model 700. In this way, a plurality of generic images 500 may be generated at step 1203 from the at least one generic 3D model 700 under the plurality of different lighting conditions.

In one example, generating the reference image set 400 from the reference image 200 at step 1205 further comprises generating one or more principal components of the at least one generic image 500. In one example, generating one or more principal components of the at least one generic image 500 comprise generating an eigenvector set from the at least one generic image 500. In one example, generating an eigenvector set may comprise generating at least one eigenimage 600 (FIG. 6) from the at least one generic image 500. The at least one modified reference image 401-406 is generated based on the reference image 200 and the at least one eigenimage 600.

In one example, generating the at least one generic 3D model 700 at step 1201 comprises generating a plurality of generic 3D models. The plurality of generic 3D models are used at step 1203 to generate a plurality of generic images 500. Step 1202 may comprise applying a plurality of different lighting conditions to the plurality of generic 3D models to generate a plurality of generic images 500 having a plurality of different lighting conditions.

In one example, generating the reference image set 400 at step 1205 further comprises generating one or more modified reference images 401-406 having different poses to the reference image 200. In one example, the one or more modified reference images 401-406 having different poses to the reference image 200 are generated using one or more pose components 1000 (FIG. 10). In one example, the one or more pose components 1000 are extracted from a plurality of library images 900 (FIG. 9).

In one example, providing the reference image 200 at step 1204 comprises providing a plurality of reference images. In one example, generating the reference image set 400 comprises generating a plurality of reference image sets. Each reference image set in one example is generated from one of the plurality of reference images.

It will be appreciated that features from the above method may be combined. For example, the method steps outlined in FIG. 3 and FIG. 11 or FIG. 3 and FIG. 12 may be combined into a single method.

While not expressly shown in the drawings, the present invention further provides a computer readable medium having computer executable code for carrying out one or more of the methods described above. The present invention further provides image recognition system for carrying out one or more of the methods described above. The image recognition system may comprise a mobile device which interacts with one or more server devices to perform the image recognition method.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An image recognition method comprising:
receiving a challenge image; and
comparing the challenge image to a reference image set generated from a reference image, the reference image set comprising at least one modified reference image having a different lighting condition to the reference image, the at least one modified reference image being generated based on the reference image and at least one generic image generated from at least one generic 3D model under the different lighting condition.

2. An image recognition method of claim 1, wherein the at least one modified image is generated based on the reference image and a plurality of generic images generated from a plurality of generic 3D models under the different lighting condition.

3. An image recognition method of claim 1, wherein the reference image set comprises a plurality of modified reference images having a plurality of different lighting conditions.

4. An image recognition method of claim 1, wherein comparing the challenge image to the reference image set comprises determining whether the challenge image matches an image of the reference image set so as to determine whether the challenge image matches the reference image.

5. An image recognition method of claim 1, wherein the at least one modified reference image is generated by applying one or more principal components of the at least one generic image to the reference image.

6. An image recognition method of claim 5, wherein applying one or more principal components of the at least one generic image to the reference image comprises applying an eigenvector set generated from the at least one generic image to the reference image.

7. An image recognition method of claim 1, wherein the reference image set comprises one or more modified reference images having different poses to the reference image.

8. An image recognition method of claim 7, wherein the one or more modified reference images having different poses to the reference image are generated using one or more pose components.

9. An image recognition method of claim 8, wherein the one or more pose components are extracted from a plurality of library images, the plurality of library images having subject matter arranged in different poses.

10. An image recognition method claim 1, wherein comparing the challenge image to the reference image set comprises comparing the challenge image to a plurality of reference image sets, each reference image set being generated from a different reference image.

11. An image recognition method of claim 10, wherein each reference image set comprises a plurality of modified reference images, the plurality of modified reference images having different poses and lighting conditions to the reference image.

12. An image recognition method of claim 10, wherein comparing the challenge image to the reference image set comprises comparing the challenge image to each of the reference image sets to determine the image which is the closest match to the challenge image so as to determine which of the reference images is the closest match to the challenge image.

13. An image recognition method claim 1, wherein the image recognition method is for use in facial recognition, wherein the generic 3D model is a generic 3D model of a face, the reference image is a reference face image, and the challenge image is a challenge face image.

14. An image recognition method comprising:
providing a reference image; and
generating a reference image set from the reference image,
wherein generating the reference image set comprises generating at least one modified reference image having a different lighting condition to the reference image, and
wherein the at least one modified reference image is generated based on the reference image and at least one generic image generated from at least one generic 3D model under the different lighting condition.

15. An image recognition method of claim 14, further comprising generating the at least one generic 3D model; applying the different lighting condition to the at least one generic 3D model; and generating the at least one generic image from the at least one generic 3D model under the different lighting condition.

16. An image recognition method of claim 15, wherein applying the different lighting condition to the at least one generic 3D model comprises applying a plurality of different lighting conditions to the at least one generic 3D model, and wherein generating the at least one generic image comprises generating a plurality of generic images from the at least one generic 3D model under the plurality of different lighting conditions.

17. An image recognition method of claim 15, further comprising generating one or more principal components of the at least one generic image.

18. An image recognition method of claim 17, wherein generating one or more principal components of the at least one generic image comprises generating an eigenvector set from the at least one generic image.

19. An image recognition method of claim 14, wherein the at least one modified reference image is generated based on the reference image and a plurality of generic images generated from a plurality of generic 3D models.

20. An image recognition method of claim 19, further comprising applying a plurality of different lighting conditions to the plurality of generic 3D models to generate a plurality of generic images having a plurality of different lighting conditions.

21. An image recognition method of claim 14, wherein generating the reference image set further comprises generating one or more modified reference images having different poses to the reference image.

22. An image recognition method of claim 21, wherein the one or more modified reference images having different poses to the reference image are generated using one or more pose components.

23. An image recognition method of claim 22, further comprising extracting the one or more pose components from a plurality of library images, the plurality of library images having subject matter arranged in different poses.

24. An image recognition method of claim 14, wherein providing the reference image comprises providing a plurality of reference images, and wherein generating the reference image set comprises generating a plurality of reference image sets, each reference image set being generated from one of the plurality of reference images.

25. A computer readable medium having computer executable code for carrying out the method of claim 1.

26. An image recognition system for carrying out the method of claim 1.
